(19) United States
(12) Patent Application Publication
(10) Pub. No.: US 2010/0325910 A1
(43) Pub. Date: Dec. 30, 2010

(54) MEASURING TAPE DEVICE WITH IMPROVED CARRIAGE APPARATUSES

(75) Inventor: Jason HUANG, Taipei (TW)

Correspondence Address: BACON & THOMAS, PLLC, 625 SLATERS LANE, FOURTH FLOOR, ALEXANDRIA, VA, 22314-1176, US

(73) Assignee: Index Measuring Tape Co., Ltd., Taipei (TW)

(21) Appl. No.: 12/491,657

(22) Filed: Jun. 25, 2009

(51) Int. Cl. G01B 3/10

(52) U.S. Cl. 33/767; 33/769

(57) ABSTRACT

A measuring tape device with improved carriage apparatuses of present invention comprises of a casing; a coiled measuring tape that is located inside the casing; one end of the measuring tape must be extended outside of the casing for taking measurement; a control mechanism that locks or releases the measuring tape is set on one end of the casing; and a side-clip component; the invention is characterized in that: the device has a protective element that is set at the front end of the casing, such protective element can prevent injury to user's finger during the retracting motion of the measuring tape, and the device may also be hanged onto a wall when it is not in use; the side-clip component is located at the top circumference surface of the casing, such that the side-clip can be assembled on either side of the casing to accommodate for both left-handed or right-handed users.

### BACKGROUND OF THE INVENTION

1. Field of the Invention

The present invention relates to a measuring tape device with improved carriage apparatuses, in particular it refers to a measuring tape device that has a protective element at the front end of the casing of the measuring tape device, the protective element not only prevents user's finger from getting injured when the measuring tape is in retracting motion, but it also provides a means so that the measuring tape device can be hanged onto a wall when it is not in use; the side-clip component of the measuring tape device is installed on the top circumference surface of the casing where the periphery is, such that the user may choose to place the side-clip component on either side of the casing panel at the user's preference.

2. Description of Prior Art

Measuring tape device is one tool that requires mobility and that is widely and frequently used, as shown in FIG. 1, a conventional measuring tape device 1 comprises of a casing 11, in which it contains a measuring tape coiled with a spring mechanism (not shown); one end of the measuring tape is connected to a hooking component 13, the hooking component 13 is joined to the measuring tape with a rivet that passes through a connection plate 14, the other end of the hooking component 13 extends perpendicularly downward to form a hook piece 15; during application, the measuring tape is pulled out using the hooking component 13 and the hooking component 13 is to hook onto or grip onto the object of measurement, a control mechanism 16 in the form of a press button is located at one end of casing 11 and the control mechanism 16 controls releasing or locking of the measuring tape when measurement is taken.

As shown in the above-mentioned figure, there is a side-clip component 17 that is located at the side panel of casing 11, the side-clip component 17 is placed in an up-side-down U position, and it is secured onto the side panel of the casing 11. The purpose of this side-clip component is to allow user to clip the measuring tape device onto his/her belt when the device is not in use.

However, there is some application deficiencies associated with conventional measuring tape device as described in the following:
1. Since the retracting movement of the measuring tape relies only on the spring located inside the measuring tape device, therefore when the measuring tape is spring-retracted at a high speed, the measuring tape may injure user's finger, it is especially dangerous when children play with this kind of measuring tape device.
2. Without a proper hanging apparatus, when idled, a measuring tape device must be stored in a drawer, and therefore the use of the device may not be as close-at-hand as one would prefer.
3. Without a proper attachment apparatus for users to clip the measuring tape devices onto their belts when they are moving around at work, users must spare one hand to carry the devices around, which causes carriage inconvenience.
4. The side-clip component of conventional measuring tape device is a rigid up-side-down U design and it allows the securing of the side-clip component onto only one factory predetermined side of the casing panels, therefore there is no adjustment option for customizing the device to accommodate for either right-handed or left-handed users.

### SUMMARY OF THE INVENTION

In view of the deficiencies found in prior art, the inventor has dedicated great efforts for years in studying and in acquiring skills for improving these deficiencies and comes up with a novel measuring tape device with double-sided hook as provided for in this invention.

The main objective of the measuring tape device with improved carriage apparatuses of present invention is to provide a protective element that is located at the front end of the casing of the measuring tape device; this protective element is to prevent injury during the retracting motion of the measuring tape.

The second objective of the measuring tape device with improved carriage apparatuses of present invention is to provide design of the protective element in the form of a long rectangular band, this design not only provides for protective function, but also provides user the convenience of carriage and allows user to hang the measuring tape device onto a wall when it is not in use.

The third objective of the measuring tape device with improved carriage apparatuses of present invention is to provide for a design with structures that allow the protective element to be either user-adjustable or predefined-at-production.

The forth objective of the measuring tape device with improved carriage apparatuses of present invention is to provide for a side-clip component that is to be secured to the casing panel, but the location or orientation of which may be adjusted according to the user's personal preference.

The fifth objective of the measuring tape device with improved carriage apparatuses of present invention is to provide a fitting position for the side-clip component be set on the circumference surface of the casing, such that with only a change of the orientation of the side-clip component, the location of the side-clip can be customized for both right-handed users and left-handed users.

A more complete understanding of these and other features and advantages of the present invention will become apparent from careful consideration of the following detailed description of certain embodiments illustrated in the accompanying drawings.

### BRIEF DESCRIPTION OF THE DRAWINGS

FIG. 1 is a three-dimension illustrative view showing a conventional measuring tape device.

FIG. 2 is a three-dimension illustrative view showing the measuring tape device of present invention.

FIG. 3 is a three-dimension partial exploded illustrative view of the measuring tape device of present invention.

FIG. 4 is a cross-sectional view showing the measuring tape device of present invention.

FIG. 5 is a top view showing the second embodiment of the measuring tape device of present invention.

FIG. 6 is a top view showing the third embodiment of the measuring tape device of present invention.

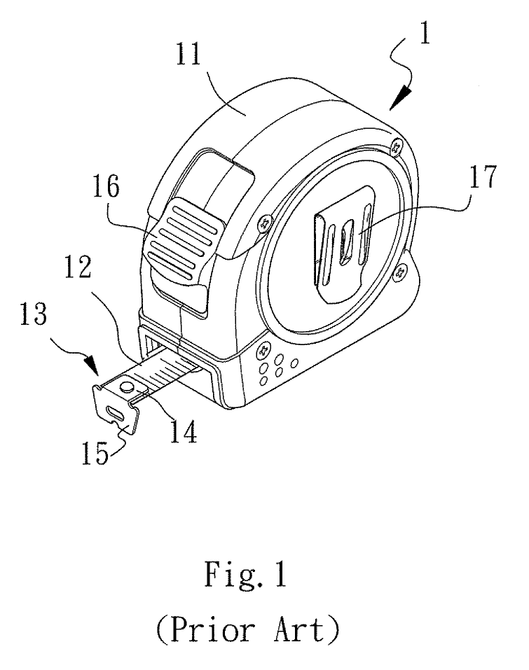

### DETAILED DESCRIPTION OF THE PREFERRED EMBODIMENTS

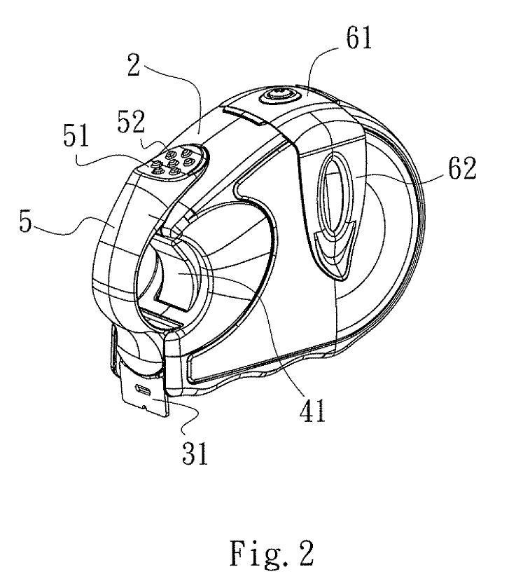

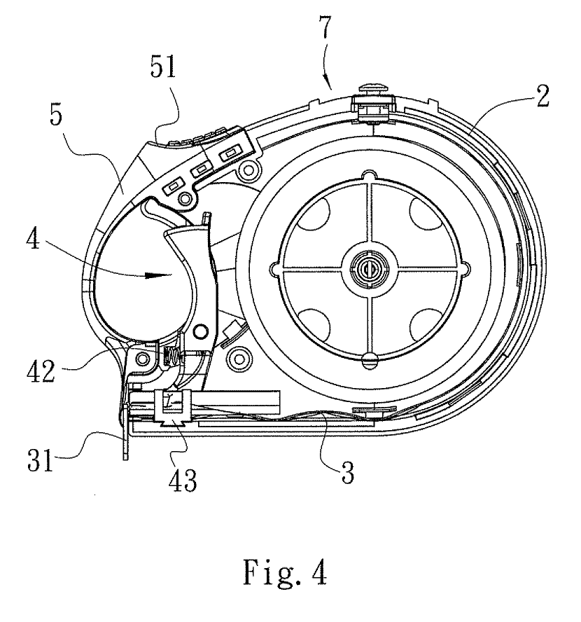

Present invention relates to a measuring tape device with improved carriage apparatuses. Referring to FIG. 2, the device comprises of a casing 2; a coiled measuring tape 3 that is located inside the casing 2 (as shown in FIG. 4); one end of the measuring tape 3 has a hooking component 31, when taking measurement, the measuring tape 3 is to be extended outside of the casing; as shown in the figure, there is a trigger control mechanism 4 at one end of the casing 2 that is to lock or to release the measuring tape 3; there is also a protective element 5, and a side-clip component 6.

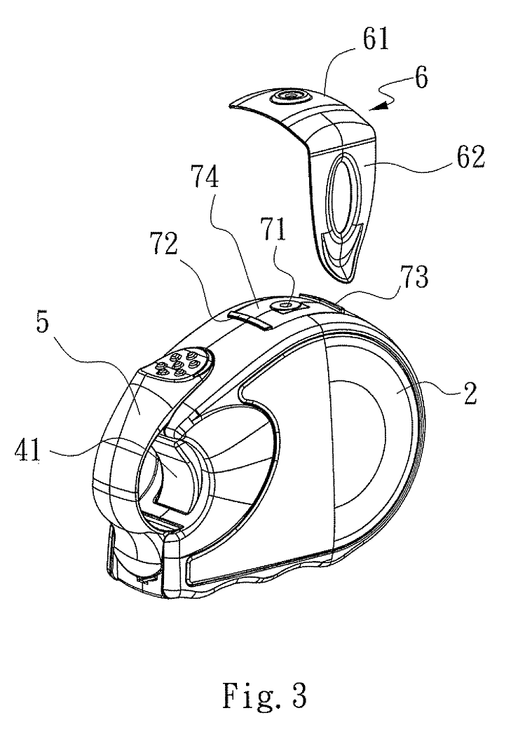

Referring to FIGS. 3 and 4, the front end of the casing is a concave arc surface, at the concave arc surface, there is the trigger control mechanism 4, this trigger control mechanism 4 comprises of a trigger push button 41 with its front and back curl forward; a crosswise spring 42 pushes against one end of the trigger push button 41; and a block 43 is joined to the bottom end of the trigger push button 41. The block 43 is positioned below the path where movement of the measuring tape takes place, as such, the measuring tape will be stopped when the trigger push button 41 is not pressed, and the measuring tape will be returned while the trigger push button 41 is pressed by user's finger.

As shown in the above-mentioned figures, the protective element 5 is a convex arc establishment of long rectangular band that is encircled around in front of the trigger push button 41; it is for preventing injury to user's finger when the measuring tape is in retracting motion. At the top end of the protective element 5 there is a touch piece 51, and there is plurality of extruded pellet 52 on the surface of the touch piece 51. This design allows user's thumb to rest against the touch piece 5 1, in so doing, the user can have a firmer grip of the protective element 5 and thus carry the measuring tape device around conveniently.

In addition to having the protective function and ease of carriage, the protective element 5 also allows the measuring tape device to be hanged on a wall when it is not in use.

As shown in the above-mentioned figures, the circumference surface of the casing 2 has a fitting position 7 for securing the side-clip component 6, at the center of the fitting position 7 is a docking aperture 71, at each side of the docking aperture, there is an extruded strip 72, 73, and a fitting space 74 is formed between the two strips 72, 73.

The side-clip component 6 comprises of an anchoring plate 61 that is to be locked onto the docking aperture 71, and a clip plate 62 that is to be placed against the side panel of the casing. This design allows the clip plate 62 be placed against either the left side panel or right side panel of the casing depends on whether the user is left-handed or right-handed.

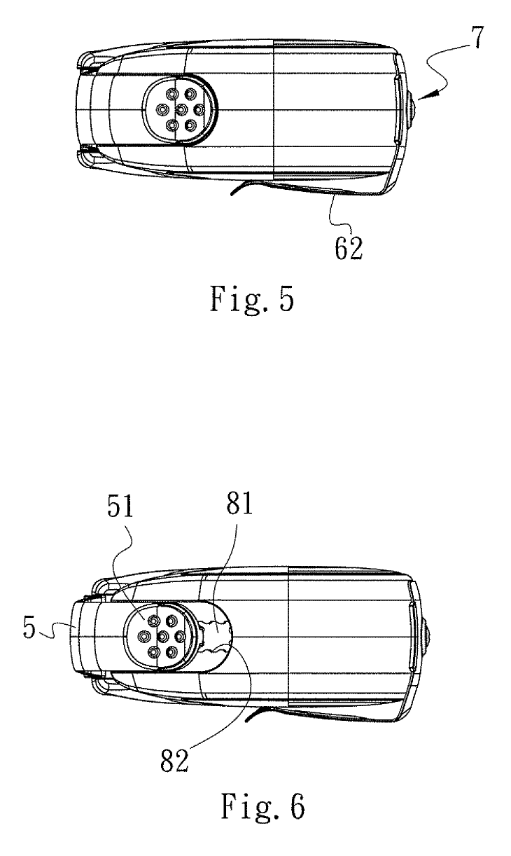

Referring to FIG. 5, in which it illustrates a second embodiment of present invention, the figure shows that the side-clip component 6 can be set to locate on the circumference's lateral surface, so that the clip plate 62 can be laterally placed against one of the side panels of the casing. This side-clip component positioning allows the hooking of the measuring tape device to be facing down when user clips the device onto his/her belt; similar to that of previously mentioned, the clip plate 62 can be placed against either the left side panel or the right side panel of the casing depends on whether the user is left-handed or right-handed.

Referring to FIG. 6, in which it illustrates a third embodiment of present invention, the figure shows that the protective element 5 is adjustable, to achieve this, a guiding plate 81 is placed in between the bottom of the touch piece 51 and the casing 2, a rack rail 82 is set on the guiding plate 81, such that the touch piece 51 can glide freely along the guiding plate 81, and therefore the position of the protective element 5 is adjusted when the guiding plate is clicked in place at the desired spot of the rack rail 82. This design allows adjustment to the protective element 5 for comfortable grip; and furthermore, when the measuring tape device is not in use, this design allows changing of the overall size of the measuring tape device for easy storage.

From the above comprehensive illustrations, the present invention of a measuring tape device with improved carriage apparatuses may be concluded to be one creative configuration never seen before. This idea has not been seen in any published printed matter and there has not been any comparable product available in the market, as such, it is undoubtedly that the present invention has its novelty. In addition, the unique characteristics and the functions of the present invention are far superior to the conventional products, and therefore it is unquestionable that the present invention is more in advance than any conventional products. As such, the present invention demonstrates its progressiveness and the application is made in accordance with the specific provisions regarding inventive patents per stated in the relevant Patent Law.

Although the present invention has been described with a certain degree of particularity, the present disclosure has been made by way of example, changes in details of the original of structure may be made without departing from the spirit hereof.

What is claimed is:

1. A measuring tape device with improved carriage apparatuses comprises of a casing, a measuring tape that is located inside the casing, a control mechanism that locks or releases the measuring tape, and a side-clip component; the characteristic of the invention is that: a protective element is configured with the measuring tape device, both ends of the protective element are joined to the casing, a space is formed between the protective element and the casing; the protective element allows user to either grip onto the measuring tape device for mobility or to hang the measuring tape device onto a wall for storage when it is not in use.

2. A measuring tape device with improved carriage apparatuses as claimed in claim 1, wherein the said protective element is in the form of band shape, a touch piece is set at the top end of the protective element, on the surface of the touch piece are plurality of extruded pellet, which allows user to have a firmer grip of the measuring tape device when his/her thumb rests against the touch piece.

3. A measuring tape device with improved carriage apparatuses as claimed in claim 1, wherein the said side-clip component comprises of an anchoring plate and a clip plate, the said anchoring plate is to be secured onto the circumference surface of the said casing, the said clip plate can be placed on either the left side panel or right side panel of the casing.

4. A measuring tape device with improved carriage apparatuses as claimed in claim 1, wherein the said protective element is encircled around in front of the trigger push button, the protective element prevents injury to user's finger during retracting motion of the measuring tape.

5. A measuring tape device with improved carriage apparatuses as claimed in claim 1, wherein the said protective element can be made to be adjustable: a guiding plate is placed in between the bottom of the touch piece and the casing, a rack rail is installed on the guiding plate so that the touch piece can glide along the guiding plate, the position of the protective element is adjusted when the guiding plate is clicked in place at the desired spot of the rack rail.
